(19) United States
(12) Patent Application Publication
(10) Pub. No.: US 2013/0103758 A1
(43) Pub. Date: Apr. 25, 2013

(54) FILTERING AND RANKING RECOMMENDED USERS ON A SOCIAL NETWORKING SYSTEM

(71) Applicants: Thomas Alison, Palo Alto, CA (US); Kiranjit S. Sidhu, Mountain View, CA (US); Carol Chia-Fan Pai, Santa Clara, CA (US); Peter H. Martinazzi, San Francisco, CA (US); Florin Ratiu, Mountain View, CA (US); Jennifer Burge, San Francisco, CA (US)

(72) Inventors: Thomas Alison, Palo Alto, CA (US); Kiranjit S. Sidhu, Mountain View, CA (US); Carol Chia-Fan Pai, Santa Clara, CA (US); Peter H. Martinazzi, San Francisco, CA (US); Florin Ratiu, Mountain View, CA (US); Jennifer Burge, San Francisco, CA (US)

(73) Assignee: c/o Facebook, Inc., Menlo Park, CA (US)

(21) Appl. No.: 13/277,180

(22) Filed: Oct. 19, 2011

(51) Int. Cl. G06F 15/16

(52) U.S. Cl. 709/204

(57) ABSTRACT

A social networking system may recommend a set of users to a viewing user for establishing new connections on the social networking system. Through a user interface, the viewing user may select filters based on characteristics and dimensions of user profile information. The recommended set of users may be ranked according to the selected filters by the number of mutual connections. Pre-populated filters may be selected and suggested based on information about the viewing user. Multiple filters may be selected by the viewing user, and filters may be based on any identifiable object in the social networking system, in one embodiment. The candidate recommended users may also be ranked based on predictions that the viewing user will initiate a request to connect with the candidate recommended users.

### BACKGROUND

This invention relates generally to social networking systems, and more particularly to filtering and ranking recommended users on a social networking system.

Users of social networking services may form connections, associations, or other relationships with other users based on real-life interactions, online interactions, or a mixture of both. For example, users may choose to connect with others from the same hometown, in the same circles of friends, as well as alumnae from the same college or university they attended. Social networking systems value strong user connectivity because users with many connections are more likely to use the social networking system, thus increasing user engagement and enhancing the user experience.

Although it is beneficial to have users with many connections within the social networking system, it may be difficult for users of a social networking system to locate other users with whom they wish to form a connection. Social networking systems generally provide a way for users to find such connections, such as searching by name, email address, or other identifying information. However, these methods are not only time and labor intensive, but also ineffective and inefficient because users may become distracted upon initially intending to find a connection on the social networking system or frustrated upon not finding users using an alias or other email address on the social networking system. In addition, users may only know partial identifying information about the potential new connection, such as a first name, a mutual friend, the potential connection's hometown, or the potential connection's current city of residence. In that case, a traditional search query for the user based on a common first name, such as Bill, will return many irrelevant results.

Social networking systems have provided mechanisms for suggesting other users that a viewing user may know but have not yet connected with. Users may be suggested to a viewing user if they are associated with the viewing user in some way, such as a university attended by the viewing user and potential connections for the user. While this method of suggesting connections may reduce the time and labor associated with locating users within the social networking system, it may also provide irrelevant suggestions because two users that attended the same university may not necessarily know each other in real life. A social networking system may also connect with a viewing user's email system and search for users with email addresses that have been contacted by the viewing user. While this method may produce potential connections, irrelevant suggestions are also provided because the viewing user may have had limited interaction with the potential connections, such as looking for roommates, purchasing used furniture, and the like.

Existing methods and tools for suggesting connections on a social networking system do not address these issues. Specifically, an interface for browsing potential connections on the social networking system has not been effectively provided to users of social networking systems. Methods and tools for filtering and ranking potential connections on the social networking system are needed to address these issues.

### SUMMARY

A social networking system may recommend a set of users to a viewing user for establishing new connections on the social networking system. Through a user interface, the viewing user may select filters based on characteristics and dimensions of user profile information. The recommended set of users may be ranked according to the selected filters by the number of mutual connections. Embodiments of the invention select pre-populated filters and suggest filters based on information about the viewing user. Multiple filters may be selected by the viewing user, and filters may be based on any identifiable object in the social networking system, in one embodiment. The candidate recommended users may also be ranked based on predictions that the viewing user will initiate a request to connect with the candidate recommended users.

### BRIEF DESCRIPTION OF THE DRAWINGS

FIG. 1 is high level block diagram illustrating a process of filtering and ranking recommended connections in a social networking system, in accordance with an embodiment of the invention.

FIG. 2 is a network diagram of a system for filtering and ranking recommended connections in a social networking system, showing a block diagram of the social networking system, in accordance with an embodiment of the invention.

FIG. 3 is a flowchart of a process of filtering and ranking recommended connections in a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users that are connected on the social networking system may also be referred to as “friends.” Users that are not connected to each other may share mutual friends on the social networking system which may be counted by the social networking system. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is further described in a related application, “Structured Objects and Actions on a Social Networking System,” U.S. application Ser. No. 13/239,340 filed on Sep. 21, 2011, which is hereby incorporated by reference.

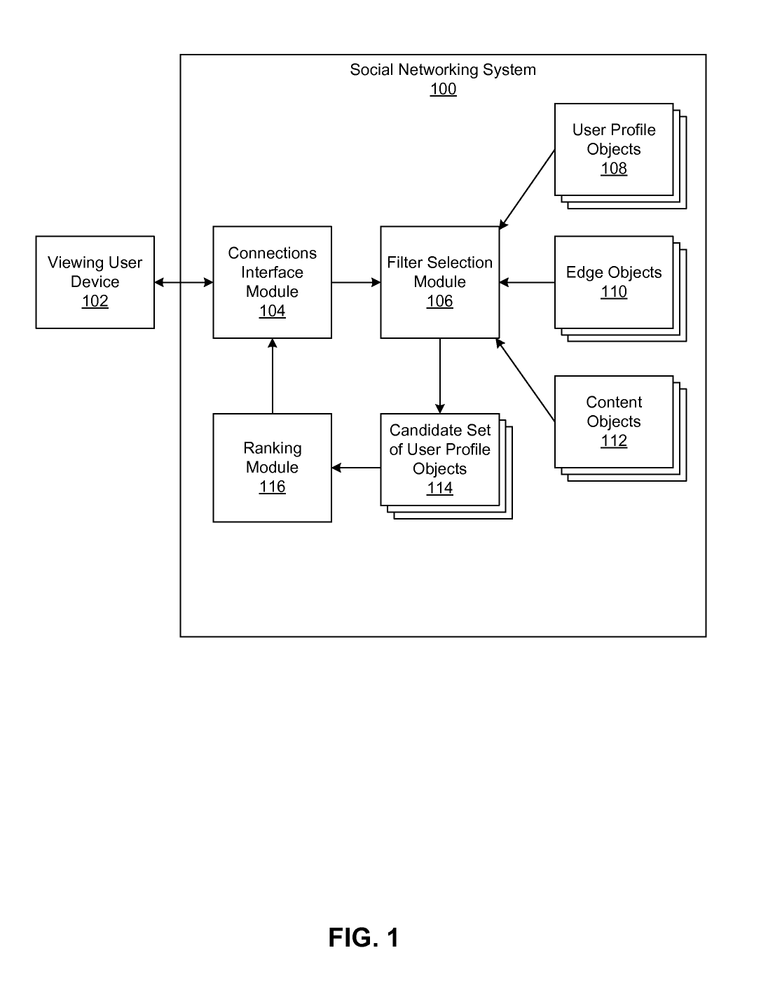

FIG. 1 illustrates filtering and ranking recommended connections in a social networking system, in one embodiment. A social networking system 100 may interact with a viewing user device 102 through a connections interface module 104. For example, a viewing user using the viewing user device 102 may request a set of candidate users that the viewing user has not yet connected with on the social networking system 100. The connections interface module 104 requests a set of filters from a filter selection module 106 based on a user profile associated with the viewing user.

The filter selection module 106 may pre-populate a set of filters for the viewing user based on user profile objects 108, edge objects 110, and content objects 112. Filters may include dimensions, or characteristics, of the viewing user's profile on the social networking system 100, retrieved from a user profile object 108 associated with the viewing user. For example, a viewing user may include a hometown, current city, high school(s) attended, college(s) attended, employer(s), and graduate school(s) attended in the user profile for the viewing user. The filter selection module 106 may retrieve these values and pre-populate the set of filters for the viewing user based on these values that are stored in the user profile object 108 for the viewing user.

The filter selection module 106 also retrieves user profile objects 108 that are not already associated with the user profile object 108 for the viewing user for inclusion in a candidate set of user profile objects 114. The filter selection module 106 may use information from edge objects 110 to determine the user profile objects 108 that are not already associated with the user profile object 108 for the viewing user. In one embodiment, content objects 112 may be analyzed by the filter selection module 106 to determine user profile objects 108 that are to be included in the candidate set of user profile objects 114. For example, users that are tagged in a photo uploaded to the social networking system 100, stored as a content object 112, may not be connected with each other. In that case, the user profile objects 108 associated with users tagged in the photo that are not connected on the social networking system 100 may be identified by the filter selection module 106.

In another embodiment, a separate process may generate a pre-computed list of users that are not already connected to the viewing user, but may include users that the viewing user may know in real-life. The filter selection module 106 may use this process to generate a candidate set of user profile objects 114. This process may utilize information about the viewing user, including existing connections on the social networking system 100, retrieved from edge objects 110, to produce the pre-computed list of users. A prediction model may be used to determine a prediction value of whether the viewing user will initiate a request to connect with each of the users in the pre-computed list of users. The process may then use a estimated value model to assign a value to the each of the users in the pre-computed list of users that estimates the value of the new connection to the social networking system 100 based on past interactions with the social networking system 100. These methods of predicting engagement for suggested connections are described further in related application, “Suggesting Entities in a Social Networking System to a User Based on a Value of the User's Interactions,” U.S. patent application Ser. No. 12/857,533, filed on Aug. 16, 2010 and hereby incorporated by reference.

Once a candidate set of user profile objects 114 has been generated by the filter selection module 106, a ranking module 116 may determine a ranking of the candidate set of user profile objects 114. The ranking module 116 may use the ranking of the pre-computed list of users, as determined by the process described above, if no filters have been selected. If a user requests more recommendations for potential connections from the social networking system 100 that exceed the pre-computed list of users, the ranking module 116 performs a query for secondary connections, or a secondary set of users that are connected to a primary set of users that are connected to the viewing user, and ranks the results of the query by a mutual user connection count.

If a filter has been selected, the ranking module 116 ranks the candidate set of user profile objects 114 based on how they match the selected filter. For example, if a user selects a mutual friend to filter the candidate set of user profile objects 114, then the candidate set of user profile objects 114 is ranked by users that are connected to the mutual friend. In one embodiment, users with profiles that do not match the selected filter are ranked below the users with profiles that match the selected filter. In another embodiment, the ranking module 116 ranks the filtered candidate set by mutual friend count, or mutual user connection count. If multiple filters have been selected, the ranking module 116 ranks the candidate set of user profile objects 114 based on how each of the user profile objects 114 match the multiple filters with equal weight for each of the filters, in one embodiment. In another embodiment, filters may be weighted differently by the ranking module 116. In a further embodiment, the ranking module 116 may apply a ranking to the filtered candidate set of user profile objects 114 based on a separate process that generates prediction values for each of the user profile objects in the candidate set of user profile objects 114 that the viewing user will initiate a request to connect with the associated users of the filtered candidate set of user profile objects 114.

After the candidate set of user profile objects 114 have been ranked by the ranking module 116, the connections interface module 104 provides the ranked candidate set of user profile objects 114 to the viewing user device 102. The connections interface module 104 may dynamically update the listing of candidate recommended users as one or more filters are selected by the viewing user. As one or more filters are selected and deselected by a viewing user through a viewing user device 102, the connections interface module 104 sends an indication to the filter selection module 106 to generate the candidate set of user profile objects 114 based on the selected filters. In one embodiment, the connections interface module 104 may receive text input from the viewing user device 102 to identify an object in the social networking system 100 to be used as a filter. For example, a viewing user that currently resides in San Francisco, Calif. may have a pre-populated filter for San Francisco, Calif. However, the viewing user may wish to identify potential new connections on the social networking system 100 that reside in Mountain View, Calif. The connections interface module 104 may receive text input from the viewing user device 102 identifying an object for Mountain View, Calif. in the social networking system 100. Upon receiving the text input from the viewing user device 102, the connections interface module 104 may then select the filter using the identified object. In one embodiment, the connections interface module 104 may enable the viewing user to specify any object on the social networking system 100 as a filter, including photos, events, groups, interests, interested in (dating), pages, applications, questions, places, deals, as well as graph objects such as songs, artists, albums, movies, books, products, and the like. In this way, users may find other users that have been tagged in the same photo, attended the same event, joined the same group, share the same interests, and even watched the same movies.

### System Architecture

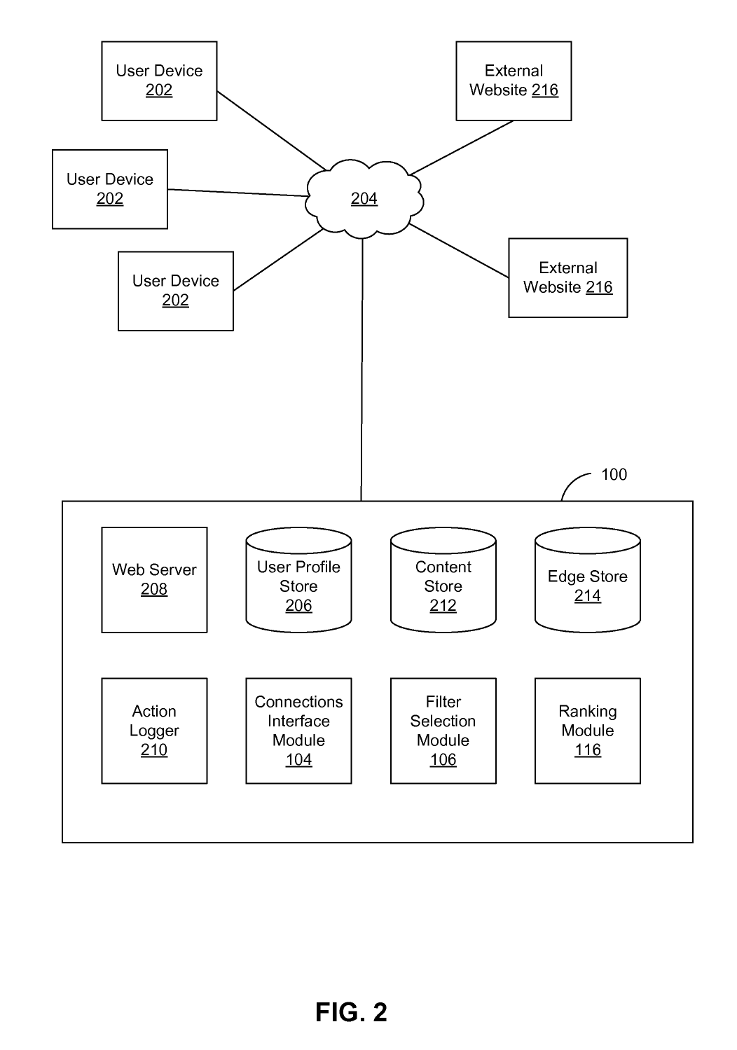

FIG. 2 is a high level block diagram illustrating a system environment suitable for enabling preference portability for users of a social networking system, in accordance with an embodiment of the invention. The system environment comprises one or more user devices 202, the social networking system 100, a network 204, and external websites 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, a web server 208, an action logger 210, a content store 212, an edge store 214, a connections interface module 104, a filter selection module 106, and a ranking module 116. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for users are stored as user profile objects 108 in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile store 206 also maintains references to the actions stored in an action log and performed on objects in the content store 212.

The edge store 214 stores the information describing connections between users and other objects on the social networking system 100 in edge objects 110. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

A connections interface module 104 provides a user interface for users of the social networking system 100 to select filters for a listing of candidate recommended users. Using the user interface provided by the connections interface module 104, one or more filters may be selected based on dimensions, or characteristics, of the viewing user's profile and pre-populated with the values of the characteristics retrieved from the viewing user's profile on the social networking system 100, in one embodiment. In another embodiment, a standard set of filters may be displayed to the viewing user by the connections interface module 104. The standard set of filters may be based on characteristics retrieved from user profile objects 108 stored in the user profile store 206. In a further embodiment, the connections interface module 104 may enable users to input text in text fields to identify objects in the social networking system 100 for filtering the candidate recommended users. These objects may include content objects 112 stored in the content store 212, such as photos, status messages, links, videos, songs, artists, books, products, and news articles.

A filter selection module 106 generates a candidate set of user profile objects 114 based on a request for recommended users from a viewing user. An initial candidate set of user profile objects 114 may comprise user profile objects that have been pre-selected by a separate process that has pre-computed prediction values for the user profile objects with respect to the viewing user. The candidate set of user profile objects 114 is retrieved from the user profile store 206. In one embodiment, the pre-selected user profile objects may be stored in the user profile object 108 for the viewing user. The filter selection module 106 may retrieve the pre-selected user profile objects stored in the user profile object 108 for the viewing user in order to generate the initial candidate set of user profile objects 114.

The filter selection module 106 may receive one or more selected filters from the connections interface module 104 to filter the initial candidate set of user profile objects 114. Suggested filters may be pre-populated in the connections interface module 104 based on user profile information for the viewing user. Thus, a hometown, a current city, a high school, a few mutual friends, a college or university, an employer, and a graduate school, for example, may be pre-populated based on the values already entered by the viewing user into his or her user profile on the social networking system 100. Other values may be manually entered and/or selected through the user interface by the viewing user. In one embodiment, any type of object on the social networking system 100 may be specified for filtering the candidate set of user profile objects 114.

The filter selection module 106 analyzes the initial candidate set of user profile objects 114 with respect to the one or more selected filters and eliminates users with profiles that do not match the one or more selected filters, in one embodiment. In another embodiment, users with profiles that do not match the one or more selected filters are ranked below the users with profiles that match the one or more selected filters. In a further embodiment, the user profile objects associated with users with profiles that do not match the one or more selected filters are analyzed to determine if one or more of the selected filters may be inferred by the social networking system 100 based on information associated with those user profile objects. For example, a user profile object for a candidate user that has a profile that does not match a selected filter, Stanford Law School, may be included in a candidate set of user profile objects 114 based on an analysis of the candidate user that reveals multiple connections to Stanford Law School, such as multiple connections that have attended the school, links to the school, and analysis of keywords that match the selected filter. In the analysis, the filter selection module 106 may use information retrieved from user profile objects 108, edge objects 110, and content objects 112. As a result, an inference algorithm may be used to enhance the number of potential new connections that have been filtered by the user.

A ranking module 116 may rank a candidate set of user profile objects 114 for display to a viewing user. In one embodiment, the ranking module 116 ranks the candidate set of user profile objects 114 by prediction values that estimate the likelihood of the viewing user initiating a connection request with the users associated with the candidate set of user profile objects 114. In another embodiment, where one or more filters have been selected, the ranking module 116 ranks the candidate set of user profile objects 114 by how the user profile objects match the one or more selected filters. For example, candidate user profile objects for a viewing user that has selected a filter based on a mutual friend, or shared user connection on the social networking system 100, may be ranked according to whether the candidate user profile object is associated with the user profile object for the selected mutual friend, such as Brittany S. Pierce. The ranking module 116 may further rank the candidate user profile objects by a mutual friend count, or the number of shared connections on the social networking system with respect to the viewing user. The mutual friend count for each of the candidate users includes the selected mutual friend, Brittany S. Pierce. In this way, an unconnected user that shares a high number of mutual friends with the viewing user, including the selected mutual friend, is ranked higher in the user interface than another unconnected user that only shares the selected mutual friend with the viewing user.

A ranking module 116 may apply different ranking based on the type of filter, or user profile characteristic. High schools, colleges, universities, and graduate schools selected as filters for the candidate recommended users may be ranked according to whether the unconnected users attended the selected school, in one embodiment. In another embodiment, unconnected users that attended different schools, but located near the selected school, may be ranked lower than users having profiles that match the selected school. Similarly, unconnected users having matching hometown and/or current city locations are ranked higher than users with profiles that do not match the selected hometown and/or current city locations. In one embodiment, a geographic proximity analysis is performed on unconnected users for use in ranking the unconnected users based on their hometown and/or current city locations listed in their user profiles.

In one embodiment, the ranking module 116 may use affinity scores for objects that are used as selected filters. For example, a user may select a filter for the artist object “Britney Spears” to identify other users that may be interested in the singer. Using affinity scores, the candidate recommended users may be ranked from highest to lowest affinity score by the ranking module 116. When multiple filters are selected, affinity scores may be used to determine the ranking of the candidate recommended users based on the combined affinity scores of the selected filters.

In a further embodiment, the ranking module 116 may apply a ranking of the candidate user profile objects by a prediction value that the viewing user will initiate a connection request, with or without selected filters. These prediction values may be pre-computed by a separate process. By storing the pre-computed prediction values for candidate users with respect to a viewing user, the social networking system 100 can present unfiltered candidate users that are ranked by likelihood that the viewing user will initiate a connection request. As a result, the social networking system 100 benefits from higher user engagement and stronger user connectivity among users based on higher numbers of mutual friends between users.

### Filtering and Ranking Candidate Recommended Users

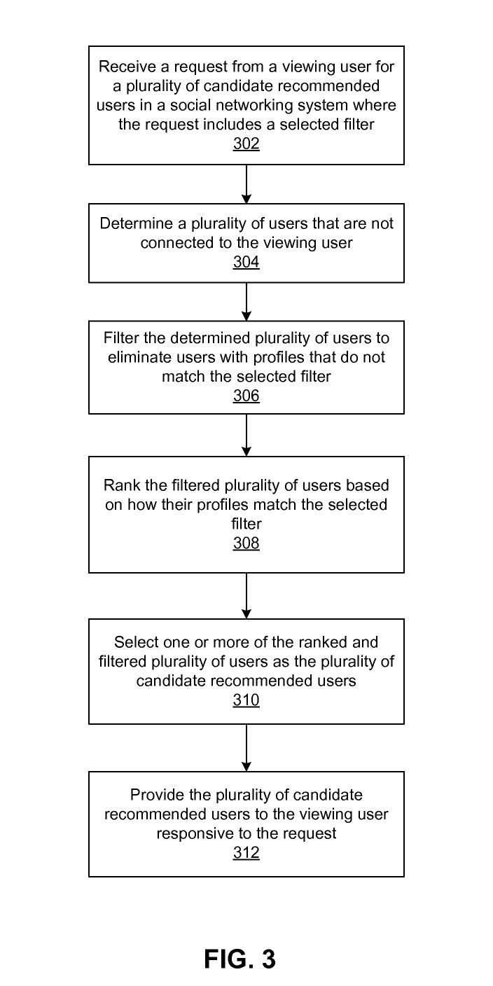

FIG. 3 illustrates a flowchart depicting a process of filtering and ranking candidate recommended users in a social networking system, in accordance with an embodiment of the invention. A social networking system 100 receives 302 a request from a viewing user for a plurality of candidate recommended users in the social networking system 100 where the request includes a selected filter. A plurality of users that are not connected to the viewing user is determined 304. This plurality of users may be determined based on edge objects associated with the user profile object for the viewing user, in one embodiment. In another embodiment, a pre-selected list of users generated from a separate process that has selected user profile objects not associated with the viewing user based on prediction values that the viewing user will initiate a connection request with the associated users is used to determine 304 the plurality of users.

After the plurality of users that are not connected to the viewing user is determined 304, the determined plurality of users is filtered 306 to eliminate users with profiles that do not match the selected filter. Users' profiles may be analyzed by retrieving the associated user profile objects associated with the users. The filtered plurality of users is ranked 308 based on how their profiles match the selected filter. For example, if a filter for hometown included Dallas, Tex. as the selected filter, then user profiles with the hometown of Dallas, Tex. would be included in the filtered plurality of users and ranked according to how the profiles matched the filter. In one embodiment, a location inference algorithm may infer a hometown for a user based on information about the user, such as where the user attended high school and where the high school is located. Other information, such as the hometown of other users that are connected to a particular user that has not filled out a hometown in his or her user profile, may be used in order to make an inference about that particular user's hometown. In another embodiment, as described above, a separate process may assign a prediction value for each of the filtered plurality of users that estimates the likelihood that the viewing user will initiate a connection request with each of the filtered plurality of users. Using these prediction values, the filtered plurality of users may be ranked 308 in addition to how their profiles match the selected filter.

The social networking system 100 may then select 310 one or more of the ranked and filtered plurality of users as the plurality of candidate recommended users. In one embodiment, the social networking system 100 may select 310 a predetermined number of users in order to fill a user interface to be provided to the viewing user for requesting a new connection. In another embodiment, the social networking system 100 may select 310 a number of users based on prediction values assigned to the users that estimates the likelihood that the viewing user will initiate a connection request. In further embodiment, the social networking system 100 may select 310 one or more of the ranked and filtered plurality of users based on whether the viewing user has previously been provided with their profiles.

The social networking system 100 then provides 312 the plurality of candidate recommended users to the viewing user responsive to the request. The social networking system may provide 312 the plurality of candidate recommended users to the viewing user in a user interface that enables the viewing user to request a new connection to each of the plurality of candidate recommended users. In one embodiment, the social networking system 100 may provide 312 the plurality of candidate recommended users to the viewing user within an advertisement on the social networking system 100. In another embodiment, the social networking system 100 may provide 312 the plurality of candidate recommended users to the viewing user in a communication directed to the viewing user, such as an email message, an instant message, a pop-up dialog box, and the like.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining a user profile for each of a plurality of users of a social networking system;
maintaining a plurality of connections established between users of the social networking system;
for a viewing user of the plurality of users, receiving a request to recommend one or more other users with whom to establish a connection in the social networking system by the viewing user, the request comprising a user profile characteristic for recommending the one or more other users;
responsive to the request,
determining a plurality of the users of the social networking system with whom the viewing user has not already established a connection; and
filtering the determined plurality of users to eliminate users with profiles that do not match the user profile characteristic, the filtering resulting in a plurality of candidate recommended users;
ranking the candidate recommended users based on a prediction that the viewing user will initiate a request to the candidate recommended users;
selecting one or more of the candidate recommended users based on the ranking; and
providing the selected candidate recommended users for display to the viewing user in an interface enabling the viewing user to establish a connection with the selected candidate recommended users.

2. The method of claim 1, wherein the ranking is based on a type of the user profile characteristic provided by the viewing user.

3. The method of claim 1, wherein the ranking is based on an inference of the user profile characteristic.

4. The method of claim 1, wherein the user profile characteristic comprises a hometown.

5. The method of claim 4, wherein the ranking is based on a geographic proximity of hometowns included in profiles of candidate recommended users with respect to the hometown included in the user profile characteristic.

6. The method of claim 1, wherein the user profile characteristic comprises a current city.

7. The method of claim 6, wherein the ranking is based on a geographic proximity of current cities included in profiles of candidate recommended users with respect to the current city included in the user profile characteristic.

8. The method of claim 1, wherein the ranking is based on a mutual friend count.

9. The method of claim 1, wherein the user profile characteristic comprises a mutual friend.

10. The method of claim 9, wherein the ranking is based on the candidate recommended users being connected to the mutual friend included in the user profile characteristic on the social networking system.

11. The method of claim 1, wherein the user profile characteristic comprises an object on the social networking system.

12. The method of claim 11, wherein the ranking is based on the candidate recommended users being associated with the object included in the user profile characteristic on the social networking system.

13. The method of claim 1, wherein the user profile characteristic comprises a location object on the social networking system.

14. The method of claim 13, wherein the ranking is based on location information about the candidate recommended users within a predetermined geographic proximity to the location object included in the user profile characteristic on the social networking system.

15. The method of claim 1, wherein the user profile characteristic comprises an interest.

16. The method of claim 15, wherein the ranking is based on affinity information about the candidate recommended users with respect to the interest included in the user profile characteristic.

17. The method of claim 1, wherein the user profile characteristic comprises a graph object defined by an entity external to the social networking system.

18. The method of claim 17, wherein the ranking is based on affinity information about the candidate recommended users with respect to the graph object included in the user profile characteristic.

19. The method of claim 1, wherein the user profile characteristic is suggested by the social networking system based on a characteristic of the user profile of the viewing user.

20. The method of claim 1, wherein the user profile characteristic is pre-populated by the social networking system based on a characteristic of the user profile of the viewing user.

21. A method comprising:
transmitting, from a user device associated with a viewing user of a social networking system, a request to the social networking system for recommending one or more other users with whom to establish a connection in the social networking system;
receiving a listing of a plurality of candidate recommended users for display in an interface on the user device, the interface including a first plurality of links for the viewing user to establish a connection with the plurality of candidate recommended users in the social networking system and a second plurality of links for selecting one or more user profile characteristics for filtering the candidate recommended users;
receiving a selection of a link of the second plurality of links, the selection associated with a specified user profile characteristic; and
responsive to the selection, rendering the listing of the plurality of candidate recommended users for display in the interface to exclude users having profiles that do not match the specified user profile characteristic.

22. The method of claim 21, further comprising:
receiving input via the user device for identifying a user profile characteristic not included in the interface; and
receiving an indication of selecting the identified user profile characteristic as the specified user profile characteristic.

23. The method of claim 21, further comprising:
receiving a selection of a link of the first plurality of links, the selection associated with a specified candidate recommended user; and
receiving an indication that a request to establish a connection with the specified candidate recommended user has been transmitted.

24. A method comprising:
maintaining a plurality of user profile objects on a social networking system, the plurality of user profile objects storing a plurality of user profiles associated with a plurality of users of the social networking system;
maintaining a plurality of edge objects on the social networking system, where each of the plurality of edge objects comprises a connection established between two users of the social networking system;
receiving a request from a viewing user for a plurality of candidate recommended users, where the request includes a selected filter;
determining a plurality of unconnected users for the viewing user, where each of the plurality of unconnected users is not connected to the viewing user;
filtering the determined plurality of unconnected users to eliminate users with profiles that do not match the selected filter;
ranking the filtered plurality of unconnected users based on the associated user profiles of the filtered plurality of unconnected users matching the selected filter;
selecting one or more of the ranked and filtered plurality of unconnected users as the plurality of candidate recommended users; and
providing the plurality of candidate recommended users for display to the viewing user in an interface enabling the viewing user to establish a connection with the plurality of candidate recommended users.

25. The method of claim 24, wherein ranking the filtered plurality of unconnected users further comprises:
ranking the filtered plurality of unconnected users based on a plurality of predictions that the viewing user will initiate a request to connect with the filtered plurality of unconnected users.

26. The method of claim 24, wherein ranking the filtered plurality of unconnected users further comprises:
ranking the filtered plurality of unconnected users based on a count of mutual connections between the plurality of unconnected users and the viewing user.

27. The method of claim 24, wherein the selected filter comprises an identification of a user connected with the plurality of unconnected users and the viewing user on the social networking system and wherein ranking the filtered plurality of unconnected users further comprises:
ranking the filtered plurality of unconnected users based on a count of mutual user connections, where the count includes the user connected with the viewing user.

28. The method of claim 24, wherein the request from a viewing user for a plurality of candidate recommended users comprises a plurality of selected filters.
